(19) United States
(12) Patent Application Publication
(10) Pub. No.: US 2024/0343600 A1
(43) Pub. Date: Oct. 17, 2024

(54) BARIUM TITANATE-BASED POWDER AND METHOD FOR PRODUCING SAME, AND FILLER FOR SEALING MATERIAL

(71) Applicant: Denka Company Limited, Chuo-ku, Tokyo (JP)

(72) Inventors: Kazuki HIROTA, Tokyo (JP); Takahisa MIZUMOTO, Tokyo (JP); Hiroaki YOSHIGAI, Tokyo (JP)

(73) Assignee: Denka Company Limited, Chuo-ku, Tokyo (JP)

(21) Appl. No.: 18/683,327

(22) PCT Filed: Aug. 9, 2022
(86) PCT No.: PCT/JP2022/030480

§ 371 Date: Feb. 13, 2024

(30) Foreign Application Priority Data
Aug. 20, 2021 (JP) 2021-134639

(51) Int. Cl. C01G 23/00; C09C 3/00; C09C 3/04

(52) U.S. Cl. CPC C01G 23/006; C09C 3/003; C09C 3/043; C01P 2004/03; C01P 2004/32; C01P 2004/61; C01P 2006/10; C01P 2006/12; C01P 2006/40

(57) ABSTRACT

A method for producing a barium titanate-based powder, the method including: step a of spraying a raw material including a barium titanate-based compound into a high-temperature field heated to a temperature equal to or higher than a melting point of the compound to form barium titanate-based particles; step b of washing a powder including the barium titanate-based particles formed in step a, or calcining a powder including the barium titanate-based particles formed in step a and then washing the calcined powder; and step c of calcining the washed powder obtained through step b.

### TECHNICAL FIELD

The present disclosure relates to a barium titanate-based powder, a method for producing the same, and a filler for a sealing material.

### BACKGROUND ART

Barium titanate-based compounds are known as materials having very high dielectric constants and are widely used as fillers and the like in various electronic component materials (for example, a sealing material or the like) that are required to have higher dielectric constants.

Barium titanate-based compounds themselves have high dielectric constants; however, the dielectric constants thereof as fillers vary depending on the production method therefor. Therefore, various methods for producing a barium titanate-based powder having a high dielectric constant have been examined.

For example, Patent Literature 1 discloses a method for producing a barium titanate powder by atomizing a barium titanate-type raw material into a high-temperature flame. According to this method, a barium titanate powder having a high dielectric constant is obtained.

### CITATION LIST

### Patent Literature

Patent Literature 1: Japanese Unexamined Patent Publication No. 2017-24925

### SUMMARY OF INVENTION

### Technical Problem

In recent years, there is a demand for the development of materials having higher dielectric constants as materials dealing with millimeter waves utilized in the 5th generation (5G) mobile communication systems (for example, a filler for a sealing material used for technologies such as antenna-in-package). Barium titanate-based powder tends to exhibit higher dielectric constants as the particle size is smaller; however, the required particle size range varies depending on the use applications. Therefore, there is a demand for the development of a technology that can improve the dielectric constant of a barium titanate-based powder regardless of the particle size range.

The present disclosure was achieved in view of the above-described circumstances, and it is a main object of the present disclosure to provide a barium titanate-based powder having an improved dielectric constant as compared to conventional barium titanate-based powder having a particle size of the same order, and a method for producing the barium titanate-based powder.

### Solution to Problem

The present disclosure provides at least the following [1] to [12].

[1] A method for producing a barium titanate-based powder, the method including: step a of spraying a raw material including a barium titanate-based compound into a high-temperature field heated to a temperature equal to or higher than a melting point of the compound to form barium titanate-based particles; step b of washing a powder including the barium titanate-based particles formed in the step a, or calcining a powder including the barium titanate-based particles formed in the step a and then washing the calcined powder; and step c of calcining the washed powder obtained through the step b.

[2] The method for producing a barium titanate-based powder according to [1], further including step d of classifying a powder including the barium titanate-based particles formed in the step a and obtaining a plurality of powders having different average particle sizes, in which in the step b, among the plurality of powders obtained in the step d, a powder having an average particle size of 3.0 to 5.0 μm and a true specific gravity of 5.60 to 5.90 g/cm³ is used as the powder including the barium titanate-based particles formed in the step a.

[3] The method for producing a barium titanate-based powder according to [1], further including step d of classifying a powder including the barium titanate-based particles formed in the step a and obtaining a plurality of powders having different average particle sizes, in which in the step b, among the plurality of powders obtained in the step d, a powder having an average particle size of 9.0 to 12.0 μm and a true specific gravity of 5.60 to 5.90 g/cm³ is used as the powder including the barium titanate-based particles formed in the step a.

[4] The method for producing a barium titanate-based powder according to any one of [1] to [3], in which in the step b, a powder including the barium titanate-based particles formed in the step a is calcined, and then the calcined powder is washed.

[5] A barium titanate-based powder including barium titanate-based particles, in which the barium titanate-based particles have a hollow area ratio in a cross-section of 5.0% or less.

[6] The barium titanate-based powder according to [5], in which the barium titanate-based powder has an average particle size of 3.0 to 12.0 μm.

[7] The barium titanate-based powder according to [5] or [6], in which the barium titanate-based powder has an average degree of sphericity of 0.80 or greater.

[8] The barium titanate-based powder according to any one of [5] to [7], in which the barium titanate-based powder has an average particle size of 3.0 to 5.0 μm and a BET specific surface area of 0.60 to 0.70 m²/g.

[9] The barium titanate-based powder according to any one of [5] to [7], in which the barium titanate-based powder has an average particle size of 6.0 to 8.0 μm and a BET specific surface area of 0.40 to 0.50 m²/g.

[10] The barium titanate-based powder according to any one of [5] to [7], in which the barium titanate-based powder has an average particle size of 9.0 to 12.0 μm and a BET specific surface area of 0.25 to 0.30 m²/g.

[11] The barium titanate-based powder according to any one of [5] to [10], in which when extraction water is prepared by mixing 30 g of the powder, 142.5 mL of ion-exchanged water having an electrical conductance of 1 μS/cm or less, and 7.5 mL of ethanol with a purity of 99.5% or higher, shaking the mixture for 10 minutes, and then leaving the mixture to stand for 30 minutes, the extraction water has an electrical conductance of 200 μS/cm or less.

[12] A filler for a sealing material, the filler including the barium titanate-based powder according to any one of [5] to [11].

### Advantageous Effects of Invention

According to the present disclosure, it is a main object to provide a barium titanate-based powder having an improved dielectric constant as compared to conventional barium titanate-based powder having a particle size of the same order, and a method for producing the barium titanate-based powder.

### BRIEF DESCRIPTION OF DRAWINGS

FIG. 1 is a SEM image showing the surface of barium titanate particles of Experimental Example 4.

FIG. 2 is a SEM image showing the surface of barium titanate particles of Experimental Example 6.

FIG. 3 is a SEM image showing a cross-section of barium titanate particles of Experimental Example 4.

FIG. 4 is a SEM image showing a cross-section of barium titanate particles of Experimental Example 6.

FIG. 5 is a SEM image showing barium titanate particles recognized by an automatic tracing tool.

### DESCRIPTION OF EMBODIMENTS

In the present specification, a numerical value range expressed using the term “to” represents a range including the numerical values described before and after the term “to” as the minimum value and the maximum value, respectively. Furthermore, the units of the numerical values described before and after the term “to” are the same, except for a case where the units are specifically indicated. With regard to a numerical value range described stepwise in the present specification, the upper limit value or lower limit value of a numerical value range of a certain stage may be replaced with the upper limit value or lower limit value of a numerical value range of another stage. Furthermore, with regard to a numerical value range described in the present specification, the upper limit value or lower limit value of the numerical value range may be replaced with a value indicated in the Experimental Examples. Furthermore, upper limit values and lower limit values described individually can be combined arbitrarily.

Hereinafter, some embodiments of the present disclosure will be described. However, the present disclosure is not intended to be limited to the following embodiments.

### <Barium Titanate-Based Powder>

A barium titanate-based powder of an embodiment includes barium titanate-based particles having a hollow area ratio in a cross-section (hereinafter, simply referred to as “hollow area ratio”) of 5.0% or less. Here, the barium titanate-based particles are particles including a barium titanate-based compound as a main component, and a barium titanate-based powder is a collection of particles, which includes barium titanate-based particles as a main component. The term “main component” means a component with the highest mass ratio (for example, a component with a mass ratio of greater than 50% by mass) among the constituent components.

Generally, perovskite-type oxides such as barium titanate have a crystal structure of ABO₃. Regarding site A and site B, substitution of elements at both sites with other elements is likely to occur easily, and it is possible to substitute a heteroelement such as Nd, La, Ca, Sr, or Zr into the crystal structure. In the present specification, in addition to barium titanate, compounds obtained by substituting the element at the above-described site A and/or site B of barium titanate with a heteroelement are collectively referred to as barium titanate-based compounds. Examples of the barium titanate-based compounds include a compound represented by the following Formula (1) and a compound represented by the following Formula (2).

(Ba₍₁₋ₓ₎Caₓ)(Ti_{(1-y)}Zr_{y})O₃ (1)

wherein in Formula (1), x and y satisfy 0≤x+y≤0.4.

LaₓBa₍₁₋ₓ₎Ti_{(1-x/4)}O₃ (2)

wherein in Formula (2), x satisfies 0<x<0.14.

In conventional barium titanate-based powder obtained by spraying a barium titanate-type raw material in a high-temperature flame, the barium titanate-based particles constituting the powder have many spaces (hollow parts) in the inside, while the above-described barium titanate-based powder includes barium titanate-based particles having a hollow area ratio of 5.0% or less as a main component and therefore has a higher dielectric constant as compared to the above-described conventional barium titanate-based powder having a particle size of the same order. This is speculated to be because since the dielectric constant of the gas (for example, air) included in the hollow part is smaller compared to the dielectric constant of barium titanate-based compounds, as the hollow area ratio is smaller, that is, as the ratio of a barium titanate-based compound included in a particle as a whole is higher, the overall dielectric constant of the particle becomes higher. Here, the phrase “having a particle size of the same order” implies that, for example, the difference in the average particle size is within 1.0 μm.

The barium titanate-based particles may be substantially composed of a barium titanate-based compound. The barium titanate-based particles may include components other than a barium titanate-based compound (impurities and the like). The content of the barium titanate-based compound may be 98 to 100% by mass, or may be 99 to 100% by mass, based on the total mass of the barium titanate-based particles.

The hollow area ratio of the barium titanate-based particles may be 4.7% or less or may be 4.4% or less. As the hollow area ratio of the barium titanate-based particles is smaller, the dielectric constant is likely to be improved. The hollow area ratio of the barium titanate-based particles may be, for example, 0.5% or greater, 1.0% or greater, 2.5% or greater, 3.5% or greater, or 4.0% or greater. That is, the hollow area ratio of the barium titanate-based particles may be 0.5 to 5.0%, 1.0 to 4.7%, 2.5 to 4.4%, or the like. The above-described hollow area ratio is the proportion of the area of hollow parts (sum of the areas of all hollow parts) present in a cross-section of a barium titanate-based particle with respect to the area of the cross-section of the barium titanate-based particle, and the hollow area ratio is calculated by determining the average particle size of the barium titanate-based particles, subsequently selecting thirty barium titanate-based particles at random, whose cross-sectional diameter is in the range of the above-described average particle size±20%, from a SEM image of a cross-section of a resin molded body including the barium titanate-based powder, and averaging the hollow area ratio of the thirty selected particles.

The extraction water electrical conductance of the barium titanate-based powder may be 200 μS/cm or less, or may be 100 μS/cm or less or 70 μS/cm or less. Here, the extraction water electrical conductance of the barium titanate-based powder means the electrical conductance of a sample liquid (extraction water) prepared by mixing 30 g of the barium titanate-based powder, 142.5 mL of ion-exchanged water having an electrical conductance of 1 μS/cm or less, and 7.5 mL of ethanol with a purity of 99.5% or higher, shaking the mixture for 10 minutes, and then leaving the mixture to stand for 30 minutes, and low extraction water electrical conductance of the barium titanate-based powder means a small quantity of ionic impurities included in the barium titanate-based powder. The extraction water electrical conductance is a value obtained by immersing an electrical conductivity cell in the sample liquid after standing, and reading out the value after one minute, and the electrical conductance of ion-exchanged water is a value obtained by immersing an electrical conductivity cell in 150 mL of ion-exchanged water and reading out the value after one minute. Measurement of the above-described electrical conductance can be performed by using an electrical conductivity cell “CM-30R” and an electrical conductivity cell “CT-57101C” manufactured by DKK-TOA Corporation. In addition, shaking in the above-described extraction operation can be performed by using a “Double Action Laboratory Shaker SRR-2” manufactured by AS ONE CORPORATION. In the present embodiment, the extraction water electrical conductance of the barium titanate-based particles may be in the above-described range.

The average particle size of the barium titanate-based powder may be 3.0 to 12.0 μm, from the viewpoint that the barium titanate-based powder is suitably used for various electronic component materials, particularly a filler for a sealing material required to have a high dielectric constant. The average particle size of the barium titanate-based powder may be, for example, 3.0 to 5.0 μm, may be 6.0 to 8.0 μm, or may be 9.0 to 12.0 μm, in accordance with the use applications. The average particle size of the barium titanate-based powder may be 3.2 μm or greater or 3.5 μm or greater, and may be 6.5 μm or less or 6.0 μm or less. The average particle size of the barium titanate-based powder may be 9.5 μm or greater or 10.0 μm or greater, and may be 11.8 μm or less or 11.5 μm or less. Here, the average particle size means the particle size at a cumulative mass of 50% (D50) in a particle size distribution obtainable by mass-based particle size measurement according to a laser diffraction light scattering method. The average particle size can be measured by using a “MASTERSIZER-3000, equipped with wet dispersion unit: Hydro MV” manufactured by Malvern Panalytical, Ltd. In the present embodiment, the average particle size of the barium titanate-based particles may be in the above-described ranges.

From the viewpoint that a material having a higher dielectric constant is easily obtained, the average degree of sphericity of the barium titanate-based powder may be 0.80 or greater, or may be 0.83 or greater, 0.85 or greater, 0.86 or greater, 0.87 or greater, 0.88 or greater, 0.89 or greater, or 0.90 or greater. The maximum value of the average degree of sphericity may be 1, or may be 0.99 or less, 0.97 or less, 0.95 or less, 0.93 or less, 0.91 or less, or 0.90 or less. The average degree of sphericity may be, for example, 0.80 to 0.99, 0.83 to 0.97, 0.85 to 0.95, 0.86 to 0.93, 0.86 to 0.91, 0.86 to 0.90, 0.87 to 0.90, 0.88 to 0.90, 0.89 to 0.90, 0.90 to 0.93, or the like. Here, the average degree of sphericity means a value measured by the following method. First, a sample powder and ethanol are mixed to prepare a slurry having a concentration of the sample powder of 1% by mass, and the slurry is subjected to a dispersion treatment by using “SONIFIER 450 (pulverizing horn ¾″ solid type)” manufactured by Branson Ultrasonics Corporation at an output power level of 8 for 2 minutes. The obtained dispersion slurry is dropped with a dropper onto a sample stage coated with a carbon paste. The dropped slurry is left to stand in air on the sample stage until the slurry dries, subsequently osmium coating is performed, and images of this are captured with a scanning electron microscope “JSM-6301F model” manufactured by JEOL Ltd. Image capturing is performed at a magnification of 3000 times, and an image with a resolution of 2048×1536 pixels is obtained. The obtained image is imported into a photographing computer, an image analysis apparatus “Mac View Ver. 4” manufactured by Mountech Co., Ltd. is used, a particle is recognized by using a simple importing tool, and the degree of sphericity is measured from the projection area (A) and the perimeter (PM) of the particle. When the area of a perfect circle corresponding to the perimeter (PM) is designated as (B), the degree of sphericity of the particle is A/B; on the other hand, when a perfect circle (radius r) having the same perimeter as the perimeter (PM) of the sample is assumed, PM=2πr and B=πr², so that B=π×(PM/2π)², and the degree of sphericity (A/B) of individual particles is A×4π/(PM)². The degrees of sphericity of two hundred particles each having any projected area equivalent circle diameter of 2 μm or greater thus obtained are determined, and the arithmetic mean value thereof is taken as the average degree of sphericity. In the present embodiment, the average degree of sphericity of the barium titanate-based particles may be in the above-described range.

From the viewpoint of obtaining a higher dielectric constant, the true specific gravity of the barium titanate-based powder may be 5.85 to 6.02 g/cm³. The true specific gravity of the barium titanate-based powder may be 5.87 g/cm³ or greater, 5.90 g/cm³ or greater, or 5.92 g/cm³ or greater, and may be 6.00 g/cm³ or less, 5.98 g/cm³ or less or 5.97 g/cm³ or less. The true specific gravity can be measured by Auto True Denser MAT-7000 model manufactured by SEISHIN ENTERPRISE Co., Ltd. In the present embodiment, the true specific gravity of the barium titanate-based particles may be in the above-described range.

The BET specific surface area of the barium titanate-based powder may be 0.60 to 0.70 m²/g, for example, in a case where the average particle size is 3.0 to 5.0 μm. A barium titanate-based powder having such a BET specific surface area tends to exhibit a higher dielectric constant. The BET specific surface area of the barium titanate-based powder may be 0.40 to 0.50 m²/g, for example, in a case where the average particle size is 6.0 to 8.0 μm. A barium titanate-based powder having such a BET specific surface area tends to exhibit a higher dielectric constant. The BET specific surface area of the barium titanate-based powder may be 0.25 to 0.30 m²/g, for example, in a case where the average particle size is 9.0 to 12.0 μm. A barium titanate-based powder having such as BET specific surface area tends to exhibit a higher dielectric constant. The BET specific surface area can be measured by a multi-point method using a He—N₂ mixed gas as the measuring gas, by using a fully automatic specific surface area measuring apparatus. In the present embodiment, the BET specific surface area of the barium titanate-based particles may be in the above-described range.

The barium titanate-based powder may be substantially composed of barium titanate-based particles. The barium titanate-based powder may include components other than the barium titanate-based particles (impurities and the like). The content of the barium titanate-based particles in the barium titanate-based powder may be 98 to 100% by mass, or may be 99 to 100% by mass, based on the total mass of the barium titanate-based powder.

Since the barium titanate-based powder described above has a high dielectric constant, the barium titanate-based powder can be used for various electron component materials and can be suitably used particularly as a filler for a sealing material required to have a high dielectric constant. In other words, another embodiment of the present disclosure is a filler for an electronic component material (preferably, for a sealing material) including the above-described barium titanate-based powder. Regarding the sealing material, for example, a sealing material used for an antenna-in-package may be mentioned. In the case of using the barium titanate-based powder as a filler for a sealing material, it is also possible to use the barium titanate-based powder as a mixture with other filler components.

### <Method for Producing Barium Titanate-Based Powder>

A method for producing a barium titanate-based powder of an embodiment includes: step a of spraying a raw material including a barium titanate-based compound into a high-temperature field heated to a temperature equal to or higher than a melting point of the compound to form barium titanate-based particles; step b of washing a powder including the barium titanate-based particles formed in step a, or calcining a powder including the barium titanate-based particles formed in the step a and then washing the calcined pulverized body; and step c of calcining the washed powder obtained through step b.

The above-described method may further include step d of classifying a powder including the barium titanate-based particles formed in the above-described step a and obtaining a plurality of powders having different average particle sizes. This step d may be carried out after step a and before step b, or may be carried out simultaneously with step a. In a case where the above-described method further includes step d, in step b, one of the plurality of powders obtained in step d is used as the powder including the barium titanate-based particles formed in step a. From the viewpoint that an intended barium titanate-based powder is easily obtained, the powder used in step b may be a powder having an average particle size of 3.0 to 5.0 μm and a true specific gravity of 5.60 to 5.90 g/cm³, or may be a powder having an average particle size of 9.0 to 12.0 μm and a true specific gravity of 5.60 to 5.90 g/cm³.

Hereinafter, each step (step a, step b, step c, and step d) in the method for producing a barium titanate-based powder will be described.

### (Step a)

In step a, a barium titanate-type raw material is sprayed into a high-temperature field to melt and solidify the raw material, barium titanate-based particles having a high degree of sphericity, and a powder including the particles is obtained.

The raw material is a solid (for example, particles) including a barium titanate-based compound. The shape of the raw material is not particularly limited and may be a regular shape or an irregular shape. The raw material may include components other than the barium titanate-based compound (for example, components such as impurities that are unavoidably contained). The content of the barium titanate-based compound in the raw material may be 98 to 100% by mass or may be 99 to 100% by mass, based on the total mass of the raw material.

The average particle size of the raw material may be 0.5 to 3.0 μm or may be 1.0 to 2.5 μm, or 1.5 to 2.0 μm. As the average particle size of the raw material is larger, the average particle size of the barium titanate-based particles obtained in step a becomes larger, and as the average particle size of the raw material is smaller, the average particle size of the barium titanate-based particles obtained in step a becomes smaller. When the average particle size of the raw material is in the above-described range, barium titanate-based particles having an average particle size of 3.0 to 5.0 μm are likely to be obtained in step a.

In step a, the raw material may be mixed with a solvent into a slurry form and then used. That is, in step a, a slurry including the raw material and a solvent may be sprayed into a high-temperature field. When a slurry is sprayed, the degree of sphericity of the barium titanate-based particles is likely to be improved by the surface tension of the solvent.

As the solvent, for example, water is used. As the solvent, an organic solvent such as methanol or ethanol can also be used for the purpose of adjusting the calorific value. These may be used singly or may be used as mixtures.

From the viewpoint that it is easy to increase the degree of sphericity of the barium titanate-based particles, the concentration (content) of the raw material in the slurry may be 1 to 50% by mass or may be 20 to 47% by mass or 40 to 45% by mass, based on the total mass of the slurry.

The high-temperature field may be, for example, a high-temperature flame formed in a combustion furnace or the like. The high-temperature flame can be formed by a combustible gas and a supporting gas. The temperature of the high-temperature field (for example, a high-temperature flame) is a temperature equal to or higher than a melting point of the barium titanate-based compound used for the raw material and is, for example, 1625 to 2000° C.

Examples of the combustible gas include propane, butane, propylene, acetylene, and hydrogen. These can be used singly, or two or more kinds thereof can be used in combination. As the supporting gas, for example, an oxygen-containing gas such as oxygen gas can be used. However, the combustible gas and the supporting gas are not limited to these.

Spraying (atomization) of the raw material can be performed by, for example, using a two-fluid nozzle. The spray velocity (supply speed) of the raw material may be 0.3 to 32 kg/h or may be 9 to 29 kg/h or 22 to 27 kg/h. When the spray velocity of the raw material is in the above-described range, the degree of sphericity of the barium titanate-based particles is likely to be increased. In the case of using a slurry, the spray velocity of the raw material in the slurry may be in the above-described range.

At the time of spraying the raw material, a dispersion gas may be used. That is, the raw material (or a slurry including the raw material) may be sprayed while being dispersed in a dispersion gas. As a result, the degree of sphericity of the barium titanate-based particles is likely to be increased. Regarding the dispersion gas, a combustion-supporting gas such as air or oxygen, an inert gas such as nitrogen or argon, and the like can be used. For the purpose of adjusting the calorific value of gases, a combustible gas may also be mixed with an inert gas. From the viewpoint that it is easy to increase the degree of sphericity of the barium titanate-based particles, the supply speed of the dispersion gas may be 20 to 50 m³/h or may be 30 to 47 m³/h or 40 to 45 m³/h.

In the above-described step a, a powder substantially composed of barium titanate-based particles can be obtained. The obtained powder contains, for example, 98 to 100% by mass or 99 to 100% by mass of the barium titanate-based particles. The barium titanate-based particles formed in the above-described step a may also include components other than a barium titanate-based compound (for example, components such as impurities that are unavoidably contained). The content of the barium titanate-based compound in the barium titanate-based particles may be 98 to 100% by mass or may be 99 to 100% by mass, based on the total mass of the barium titanate-based particles.

The degree of sphericity of the barium titanate-based particles (average degree of sphericity of the powder including barium titanate-based particles) formed in the above-described step a is, for example, greater than 0.70. In the above-described step a, the degree of sphericity of the barium titanate-based particles (average degree of sphericity of the powder including barium titanate-based particles) can be adjusted to be 0.80 or greater or 0.85 or greater, by adjusting the spray velocity of the raw material, using a slurry, using a dispersion gas, and the like. In addition, in the case of carrying out step d that will be described below, it is also possible to further increase the degree of sphericity by classification. The maximum value of the degree of sphericity of the barium titanate-based particles (average degree of sphericity of the powder including barium titanate-based particles) is 1.

### (Step d)

In step d, a powder including the barium titanate-based particles formed in step a is classified. The method for classification is not particularly limited and may be screen classification or air classification. From the viewpoint of efficiently performing classification, a method of directly connecting a collection system line to the lower part of the combustion furnace where step a is carried out, and suctioning the barium titanate-based particles into the combustion furnace through the collection system line by means of a blower installed behind the collection system line (on the opposite side from the combustion furnace) may be used. The collection system line may have a cyclone and a bag filter in addition to a thermal exchanger connected to the combustion furnace. The heat exchanger, cyclone, and bag filter may be connected in series in this order. In this case, a powder including the barium titanate-based particles is collected at each of the combustion furnace, heat exchanger, cyclone, and bag filter. The particle size of each powder to be collected can be adjusted by, for example, the suction amount of the blower.

In a case where the above-described collection system line is used in step d, the powder collected at a side toward the upstream direction (side closer to the combustion furnace) tends to have a true specific gravity closer to the specific gravity of the barium titanate-based compound. Inside the above-described collection system line, the true specific gravity of the powder collected by the heat exchanger and the true specific gravity of the powder collected by the cyclone are the closest to the specific gravity of the barium titanate-based compound and are, for example, 5.60 to 5.90 g/cm³. The true specific gravity of these powders can also be 5.60 to 5.80 g/cm³, 5.65 to 5.78 g/cm³, or 5.70 to 5.75 g/cm³. The reason why such a true specific gravity is obtained is speculated that impurities having small specific gravity (barium carbonate and the like) are more likely to be mixed into the powder to be collected as the site is further toward the downstream direction (side closer to the blower). As the specific gravity of the powder is closer to the true specific gravity of the barium titanate-based compound, it is easier to obtain an effect of improving the dielectric constant by calcination of the step b and step c that will be described below. Furthermore, in the case of using the above-described collection system line in step d, the degree of sphericity of the powder to be collected by the cyclone tends to be the highest.

In step d, classification of the powder may be performed such that the average particle size of at least one of the obtained powders (powders including the barium titanate-based particles) is 5.0 μm or less. By using a powder having the above-described average particle size in step b, a washing effect in step b tends to be improved, and an effect of improving the dielectric constant by calcination in step b and step c is more likely to be obtained. A powder having such an average particle size can be collected by a cyclone. The average particle size of the powder collected by a cyclone is, for example, 3.0 to 5.0 μm and can also be 3.2 to 4.8 μm or 3.5 to 4.5 μm.

In step d, classification of the powder may be performed such that the average particle size of at least one of the obtained powders (powders including the barium titanate-based particles) is 9.0 to 12.0 μm. A powder having such an average particle size can be collected by a heat exchanger. The average particle size of the powder to be collected by a heat exchanger can be 9.5 to 11.8 μm or 10.0 to 11.5 μm.

### (Step b)

Step b is a step of washing a powder including the barium titanate-based particles formed in step a, or a step of calcining a powder of including the barium titanate-based particles formed in step a and then washing the calcined powder. Calcination before washing is an optional step; however, when calcination is performed, an effect of removing impurities by washing tends to be improved, and a barium titanate-based powder having higher purity and a higher dielectric constant is likely to be obtained.

Regarding the powder including barium titanate-based particles formed in step a, one of a plurality of powders obtained by classifying the powder including the barium titanate-based particles formed in step a may be used. That is, in step b, one of the powders obtained in step d may be used. In a case where the above-described collection system line is used in step d, when the powder collected by a cyclone is used, the washing effect tends to be improved, and the dielectric constant of the barium titanate-based powder obtained in step c tends to be further improved. From the viewpoint of obtaining high-purity barium titanate that does not contain other powders such as barium carbonate as far as possible, the powder collected by a heat exchanger may be used.

From the viewpoint that the washing effect is likely to be improved and from the viewpoint that the dielectric constant of the barium titanate-based powder is more likely to be improved, the average particle size of the powder used in step b may be 5.0 μm or less or may be 4.8 μm or less or 4.5 μm or less. From the viewpoint of preventing aggregation and coalescence between the particles during calcination, the average particle size of the powder used in step b may be 3.0 μm or greater or may be 3.2 μm or greater or 3.5 μm or greater. From these viewpoints, the average particle size of the powder used in step b may be 3.0 to 5.0 μm, 3.2 to 4.8 μm, or 3.5 to 4.5 μm.

From the viewpoint that high-purity spherical barium titanate is likely to be obtained, the average particle size of the powder used in step b may be 9.0 to 12.0 μm. From a similar viewpoint, the average particle size of the powder used in step b may be 9.5 μm or greater or 10.0 μm or greater, may be 11.8 μm or less or 11.5 μm or less, or may be 9.5 to 11.8 μm or 10.0 to 11.5.

From the viewpoint that the dielectric constant of the obtained barium titanate-based powder is more likely to be improved, the true specific gravity of the powder used in step b may be 5.60 to 5.90 g/cm³ or may be 5.60 to 5.80 g/cm³, 5.65 to 5.78 g/cm³, or 5.70 to 5.75 g/cm³. As the true specific gravity of the powder used in step b is closer to the specific gravity of the barium titanate-based compound, an effect of improving the dielectric constant by calcination is likely to be obtained.

From the above-described viewpoint, according to one embodiment, the powder including barium titanate-based particles used in step b may be a powder having an average particle size of 3.0 to 5.0 μm and a true specific gravity of 5.60 to 5.90 g/cm³. In the case of using the above-described collection system line in step d, a powder having such an average particle size and such a true specific gravity can be easily obtained by collection by a cyclone (cyclone collection).

From the above-described viewpoint, according to one embodiment, the powder including barium titanate-based particles used in step b may be a powder having an average particle size of 9.0 to 12.0 μm and a true specific gravity of 5.60 to 5.90 g/cm³. In the case of using the above-described collection system line in step d, a powder having such an average particle size and such a true specific gravity can be easily obtained by collection by a heat exchanger (heat exchanger collection).

The average degree of sphericity of the powder used in step b may be 0.80 or greater or may be 0.82 or greater or 0.85 or greater. The maximum value of the average degree of sphericity is 1.

For the calcination (heating) of the powder, a calcination furnace may be used. The calcination temperature (for example, temperature inside a calcination furnace) for the powder is, for example, 700° C. or higher or may be 800° C. or higher, 900° C. or higher, 1000° C. or higher, or 1100° C. or higher. The calcination temperature of the powder is, for example, 1300° C. or lower, and from the viewpoint of improving the degree of sphericity, the calcination temperature may be 1200° C. or lower, 1100° C. or lower, or 1000° C. or lower. From the viewpoint that the washing effect is likely to be improved and from the viewpoint that the dielectric constant of the barium titanate-based powder is more likely to be improved, the calcination temperature for the powder may be 800 to 1200° C. or 900 to 1100° C. The temperature increase rate is not particularly limited and may be 2 to 5° C./min or may be 2.5 to 4.5° C./min or 3 to 4° C./min.

From the viewpoint that the washing effect is likely to be improved and from the viewpoint that the dielectric constant of the barium titanate-based powder is more likely to be improved, the calcination time of the powder may be 2 hours or longer or may be 4 hours or longer or 6 hours or longer. When the calcination time for the powder is 6 hours or longer, the tendency to improve the above-described washing effect and the tendency to improve the dielectric constant are decreased, and therefore, from the viewpoint of the production efficiency, the calcination time for the powder may be 8 hours or shorter. The above-described calcination time does not include the time for temperature increase.

The cooling conditions after calcination are not particularly limited. Cooling after calcination may be natural cooling inside the furnace.

Washing is performed by bringing the powder including the barium titanate-based particles formed in step a or the calcined powder (hereinafter, these are collectively referred to as “powder to be washed”), into contact with a washing liquid. Regarding the calcined powder, the powder obtained by the above-described calcination may be used as it is, or a powder obtained by subjecting the powder obtained by the above-described calcination to a treatment such as classification may be used. Washing may be performed by, for example, introducing the powder to be washed into a washing liquid and stirring the mixture. At this time, the temperature of the washing liquid may be 10 to 25° C. Stirring can be performed by, for example, using a stirrer, a magnetic stirrer, or a disperser. The stirring time may be 5 to 30 minutes. The stirring rate may be 200 to 400 rpm.

The washing liquid is a washing liquid capable of dissolving and removing impurities (particularly, ionic impurities) generated during the production of barium titanate-based particles. Regarding such a washing liquid, for example, a water-based washing liquid is used. The water-based washing liquid is a washing liquid including water as a main component. The content of water in the water-based washing liquid may be 60 to 100% by mass, 70 to 100% by mass, or 80 to 100% by mass, based on the total mass of the water-based washing liquid. The water-based washing liquid may be composed only of water (for example, pure water) or may include another constituent component. Examples of the other constituent component include ethanol and acetone. As long as the above-described impurities can be removed, the washing liquid does not have to include water. As the washing liquid, for example, a washing liquid that includes components that can dissolve barium carbonate (for example, ethanol, acetone, hydrogen chloride, and nitric acid) but does not include water, can also be used.

From the viewpoint that a washing effect is likely to be obtained, the amount of the powder to be washed that is to be brought into contact with the washing liquid may be 10 to 40 parts by mass or may be 15 to 35 parts by mass or 20 to 30 parts by mass, with respect to 100 parts by mass of the washing liquid. The above-described amount is the amount of the powder to be washed that is brought into contact with the washing liquid per time of washing.

Washing may be repeatedly performed a plurality of times. For example, washing may be performed by introducing the powder to be washed into the washing liquid, stirring the mixture, subsequently allowing the powder to settle, subsequently removing the supernatant, adding the washing liquid again thereto, and stirring the mixture. The purity can be further increased by increasing the number of times of washing. The number of times of washing may be two or more times or may be three or more times. The number of times of washing may be ten or fewer times or may be five or fewer times. As the number of times of washing is smaller, the dielectric constant of the obtained barium titanate-based powder tends to increase. In the case of performing calcination before washing, ionic impurities can be sufficiently removed with a smaller number of times of washing.

In step b, a drying treatment of the washed powder may be performed. The drying conditions may be conditions in which the washed barium titanate-based particles (barium titanate-based powder) can be sufficiently dried. The drying temperature may be 100 to 110° C. The drying time may be 12 to 24 hours.

### (Step c)

In step c, the washed powder obtained through step b is calcined. The washed powder is a powder obtained by performing the above-described washing treatment and may also be a powder after the above-described drying treatment.

Calcination of the powder may be performed in the same manner as in step b, and the calcination temperature, the temperature increase rate, and the calcination time may be adjusted in the ranges mentioned as an example in step b. From the viewpoint that the proportion of the hollow part is more likely to be reduced, and a higher dielectric constant is likely to be obtained, the calcination temperature (for example, temperature inside the calcination furnace) of the powder may be 800 to 1200° C. or 900 to 1100° C.

According to the method for producing a barium titanate-based powder described above, a barium titanate-based powder having a higher dielectric constant can be obtained. Specifically, a powder including barium titanate-based particles having a small hollow area ratio in a cross-section (barium titanate-based powder) can be obtained. The hollow area ratio of the barium titanate-based particles in the barium titanate-based powder obtained by the above-described method is, for example, 5.0% or less and can also be 4.7% or less or 4.4% or less.

Furthermore, the barium titanate-based powder obtained by the above-described method has high purity. Specifically, the extraction water electrical conductance of the barium titanate-based powder produced by the above-described method is, for example, 200 μs/cm or less. The extraction water electrical conductance of the barium titanate-based powder can be further decreased by increasing the number of times of washing and can also be set to 100 μS/cm or less or 70 μS/cm or less.

The reason why a barium titanate-based powder having high purity and an improved dielectric constant is obtained by the above-described method is not clearly understood but is speculated as follows.

It has been verified by the inventors of the present disclosure that when the barium titanate-based particles obtained in step a are calcined at a high temperature, the proportion of the hollow parts of the barium titanate-based particles is decreased, and the dielectric constant is improved. However, since the barium titanate-based particles obtained in step a include impurities, when the impurities are removed by washing, hollow parts are generated in the regions where the impurities were present. Therefore, even though calcination is performed, in a case where washing is performed thereafter, the dielectric constant is decreased due to an increase in the hollow parts. In contrast, in the above-described method, since calcination is performed after washing, hollow parts generated by washing shrink, and the proportion of hollow parts in the barium titanate-based particles is decreased. Furthermore, since impurities have adverse effect even on the dielectric constant, in the above-described method, the dielectric constant can be improved as compared to a method of not performing washing. From these reasons, it is speculated that the above-described effect is obtained.

The barium titanate-based powder obtained by the above-described method tends to have a high degree of sphericity. The average degree of sphericity of the barium titanate-based powder obtained by the above-described method is, for example, 0.80 or greater and can also be 0.83 or greater, 0.85 or greater, 0.86 or greater, 0.87 or greater, 0.88 or greater, 0.89 or greater, or 0.90 or greater. The maximum value of the average degree of sphericity is 1, and a barium titanate-based powder having an average degree of sphericity close to 1 (for example, 0.80 to 0.99, 0.83 to 0.97, 0.85 to 0.95, 0.86 to 0.93, 0.86 to 0.91, 0.86 to 0.90, 0.87 to 0.90, 0.88 to 0.90, 0.89 to 0.90, 0.90 to 0.93, or the like) can be obtained by the above-described method.

The barium titanate-based powder obtained by the above-described method tends to have a true specific gravity close to the specific gravity of barium titanate-based compounds. The true specific gravity of the barium titanate-based powder obtained by the above-described method is, for example, 5.85 to 6.02 g/cm³ and can also be 5.87 to 6.00 g/cm³, 5.90 to 5.98 g/cm³, 5.92 to 6.00 g/cm³, 5.92 to 5.98 g/cm³, or 5.92 to 5.97 g/cm³.

The average particle size of the barium titanate-based powder obtained by the above-described method is, for example, 3.0 to 12.0 μm. In step b, in a case where a powder having an average particle size of 3.0 to 5.0 μm (for example, a powder collected by a cyclone) among a plurality of powders obtained in step d is used, a barium titanate-based powder having an average particle size of 3.0 to 5.0 μm can be obtained. In addition, in step b, in a case where a powder having an average particle size of 9.0 to 12.0 μm (for example, a powder collected by a heat exchanger) among a plurality of powders obtained in step d is used, a barium titanate-based powder having an average particle size of 9.0 to 12.0 μm can be obtained. The average particle size of the barium titanate-based powder can be 3.2 μm or greater or 3.5 μm or greater and can also be 6.5 μm or less or 6.0 μm or less. Furthermore, the average particle size of the barium titanate-based powder can be 9.5 μm or greater or 10.0 μm or greater and can also be 11.8 μm or less or 11.5 μm or less. The average particle size can be adjusted by combining a plurality of the barium titanate-based powders obtained by the above-described method. For example, a barium titanate-based powder may be obtained by combining a barium titanate-based powder obtained in step b by using a powder having an average particle size of 3.0 to 5.0 μm (for example, a powder collected by a cyclone), with a barium titanate-based powder obtained in step b by using a powder having an average particle size of 9.0 to 12.0 μm (for example, a powder collected by a heat exchanger). The average particle size of the barium titanate-based powder thus obtained is, for example, 6.0 to 8.0 μm.

In the above-described method, since the particles acquire a dense structure by calcination, the BET specific surface area of the barium titanate-based powder obtained by the above-described method tends to be small compared to the specific surface area of a barium titanate-based powder obtained by another method. Specifically, for example, under the conditions of setting the average particle size to be 3.0 to 5.0 μm, a barium titanate-based powder having a BET specific surface area of 0.60 to 0.70 m²/g can be obtained. In addition, for example, under the conditions of setting the average particle size to be 9.0 to 12.0 μm, a barium titanate-based powder having a BET specific surface area of 0.25 to 0.30 m²/g can be obtained. Furthermore, as described above, in a case where the average particle size is set to 6.0 to 8.0 μm by combining a plurality of barium titanate-based powders, a barium titanate-based powder having a BET specific surface area of 0.40 to 0.50 m²/g can be obtained.

### EXAMPLES

Hereinafter, the contents of the present disclosure will be described in more detail by using Experimental Examples; however, the present disclosure is not intended to be limited to the following Experimental Examples.

### Experimental Examples 1 and 2

### (Preparation of Raw Materials)

As a raw material, “BT-SA” (trade name, barium titanate powder, average particle size: 1.6 μm) manufactured by KCM Corporation was prepared, and this was mixed with water to prepare a slurry (concentration of BT-SA: 43% by mass).

### (Step a: Formation of Barium Titanate Particles)

An apparatus including: a combustion furnace in which an LPG-oxygen mixed type burner having a double-tube structure capable of forming inner flames and outer flames was installed at the top, a collection system line directly connected to the lower part of the combustion furnace, and a blower connected to the collection system line, was prepared. The collection system line has a heat exchanger connected to the combustion furnace, a cyclone connected to the upper part of the heat exchanger, and a bag filter connected to the upper part of the cyclone, and the bag filter is connected to the blower.

A high-temperature flame (temperature: about 2000° C.) was formed inside the combustion furnace of the above-described apparatus, and from the central part of the burner, the above-described slurry was entrained into carrier air (supply rate: 40 to 45 m³/h) and sprayed at a supply rate of 37 L/Hr (25 kg/h in terms of BT-SA). The flame was formed by providing several dozen pores at the outlet port of the burner having a double-tube structure and spraying a mixed gas of LPG (supply rate 17 m³/h) and oxygen (supply rate 90 m³/h) through the pores. As a result, spherical-shaped barium titanate particles were formed.

### (Step d: Classification of Powder Including Barium Titanate Particles)

A powder including the barium titanate particles formed in the combustion furnace was suctioned by the blower, and powders including barium titanate particles were collected by each of the combustion furnace, the heat exchanger, the cyclone, and the bag filter. Among the collected plurality of powders, the powder collected by the heat exchanger (heat exchange product) was designated as a barium titanate powder of Experimental Example 1, and the powder collected by the cyclone (CY product) was designated as a barium titanate powder of Experimental Example 2.

### (Measurement of True Specific Gravity)

The true specific gravities of the barium titanate powders obtained in Experimental Examples 1 and 2 were measured by Auto True Denser MAT-7000 model manufactured by SEISHIN ENTERPRISE Co., Ltd. The results are shown in Table 1.

### (Measurement of Average Degree of Sphericity)

The average degrees of sphericity of the barium titanate powders obtained in Experimental Examples 1 and 2 were measured by the following method. First, a barium titanate powder and ethanol were mixed to prepare a slurry having a concentration of the barium titanate powder of 1% by mass, and the slurry was subjected to a dispersion treatment by using a “SONIFIER 450 (pulverization horn ¾″ solid type)” manufactured by Branson Ultrasonics Corporation at an output power level of 8 for 2 minutes. The obtained dispersion slurry was dropped with a dropper onto a sample stage coated with a carbon paste. The dropped slurry was left to stand in air on the sample stage until the slurry dried, subsequently osmium coating was performed, and images of this were captured with a scanning electron microscope “JSM-6301F model” manufactured by JEOL Ltd. Image capturing was performed at a magnification of 3000 times, and an image with a resolution of 2048×1536 pixels was obtained. The obtained image was imported into a photographing computer, an image analysis apparatus “Mac View Ver. 4” manufactured by Mountech Co., Ltd. was used, and particles were recognized by using a simple importing tool. From the projection areas (A) and the perimeters (PM) of the particles, the degrees of sphericity of two hundred particles each having any projected area equivalent circle diameter of 2 μm or greater thus obtained were determined, and the average value thereof was taken as the average degree of sphericity. The results are shown in Table 1.

### (Measurement of Average Particle Size)

The average particle sizes (D50) of the barium titanate powders obtained in Experimental Examples 1 and 2 were determined by measuring the particle size on a mass basis according to a laser diffraction light scattering method using a “MASTERSIZER-3000, equipped with wet dispersion unit: Hydro MV” manufactured by Malvern Panalytical, Ltd. On the occasion of the measurement, a barium titanate powder and water were mixed, the mixed liquid was subjected to a dispersion treatment by applying an output power of 200 W using an “Ultrasonic Generator UD-200 (equipped with a microtip TP-040)” manufactured by TOMY SEIKO CO., LTD. for 2 minutes as a pretreatment, and then the mixed liquid obtained after the dispersion treatment was dropped on a dispersion unit such that the laser scattering intensity was 10 to 15%. The stirring speed of the dispersion unit stirrer was set to 1750 rpm, and measurement was made without the ultrasonic mode. Analysis of the particle size distribution was performed by dividing the particle size range of 0.01 to 3500 μm into 100 portions. A refractive index of 1.33 was used for water, and a refractive index of 2.40 was used for barium titanate. The results are shown in Table 1.

### (Measurement of Extraction Water Electrical Conductance)

The extraction water electrical conductances of the barium titanate powders obtained in Experimental Examples 1 and 2 were measured by the following method. First, 30 g of a barium titanate powder was introduced into a 300-mL polyethylene container, and then 142.5 mL of ion-exchanged water having an electrical conductance of 1 μS/cm or less and 7.5 mL of ethanol having a purity of 99.5% or higher were added. Next, a sample liquid (extraction water) was prepared by shaking the obtained mixed liquid for 10 minutes by a reciprocating vibration method by using a “Double Action Laboratory Shaker SRR-2” manufactured by AS ONE CORPORATION and then leaving the mixed liquid to stand for 30 minutes. An electrical conductivity cell was immersed in the sample liquid after standing, a value was read out after 1 minute, and this was taken as the extraction water electrical conductance. Regarding the electrical conductance of the ion-exchanged water, an electrical conductivity cell was immersed in 150 mL of ion-exchanged water, and a value read out after 1 minute was used. Furthermore, for the measurement of the electrical conductance, an electrical conductivity meter “CM-30R” and an electrical conductivity cell “CT-57101C” manufactured by -DKK-TOA Corporation were used.

### (Measurement of BET Specific Surface Area)

The BET specific surface areas of the barium titanate powders obtained in Experimental Examples 1 and 2 were measured by the following method. First, a blank cell was filled with 4 g of a barium titanate powder, and a degassing treatment was performed in an environment at 300° C. After the degassing treatment, the cell filled with the barium titanate powder was mounted in a fully automatic specific surface area measurement apparatus “Macsorb Model 1208” manufactured by Mountech Co., Ltd., and the specific surface area was measured. A He—N₂ mixed gas was used as the measurement gas, and measurement was performed by a multi-point method at a main body flow rate value of 25 mL/min. The results are shown in Table 1.

### (Evaluation of Dielectric Constant)

A resin composition was produced by using each of the barium titanate powders obtained in Experimental Examples 1 and 2, and an effect of improving the dielectric constant by a barium titanate powder was evaluated by using the dielectric constant of a cured product of the resin composition (resin cured product). Specifically, first, 95.4 g of a barium titanate powder, 11.1 g of an epoxy resin (manufactured by Mitsubishi Chemical Corporation, trade name “jER-807” (“jER” is a registered trademark)), 3.3 g of a phenol-based curing agent (manufactured by Meiwa Kasei Co., Ltd., trade name “MEH-8005”), 0.15 g of an imidazole-based curing agent (manufactured by SHIKOKU CHEMICALS CORPORATION, trade name “2PHZ-PW”), 0.15 g of a catalyst (manufactured by FUJIFILM Wako Pure Chemical Corporation, trade name “TRIPHENYLPHOSPHINE”), 0.3 g of a release agent (manufactured by Clariant Japan, “LICOWAX E” (“LICOWAX” is a registered trademark)), and 0.15 g of a surface treatment agent (manufactured by Shin-Etsu Chemical Co., Ltd., trade name “KBM-403”) were mixed, and a resin composition was obtained. Next, the obtained resin composition was allowed to flow into a silicon tube having an inner diameter of 25 mm and was cured by leaving the resin composition to stand for 10 hours in an atmosphere at 120° C., and an evaluation sample formed from the resin cured product was obtained. The dielectric constant of the obtained evaluation sample was measured by a static capacitor method by using a dielectric constant measuring device “E4980A PRECISION LCR METER” manufactured by Keysight Technologies. The results are shown in Table 1.

TABLE 1

| | | Experimental | Experimental |
|---|---|---|---|
| | | Example 1 | Example 2 |
| Type of powder used | | Heat exchange | CY product |
| | | product | |
| Step b | Calcination | Absent | Absent |
| | Washing | Absent | Absent |
| Step c | Calcination | Absent | Absent |

| | | |
|---|---|---|
| True specific gravity (—) | 5.72 | 5.73 |
| Average degree of sphericity (—) | 0.86 | 0.86 |
| Average particle size (μm) | 11.0 | 3.9 |
| Extraction water electrical conductance | 300 | 3000 |
| (μS/cm) | | |
| BET specific surface area (m²/g) | 1.13 | 2.27 |
| Dielectric constant of resin cured | 24 | 23 |
| product (—) | | |

### Experimental Example 3

Step a (formation of barium titanate particles) and step d (classification of powder including barium titanate particles) were carried out in the same manner as in Experimental Examples 1 and 2, and then, as step b, a calcination step (step b1) and a washing step (step b2), which will be described below, were carried out on a powder collected by a heat exchanger (heat exchange product).

### (Step b1: Calcination Step)

8 kg of the powder collected by a heat exchanger was charged into a mullite sheath, the temperature was increased to 1000° C. at a temperature increase rate of 3.3° C./min, and then the powder was calcined at 1000° C. for 6 hours to obtain a calcination product. Cooling after calcination was performed by natural cooling in a furnace.

### (Step b2: Washing Step)

For the calcination product (powder after calcination) obtained in step b1, a water washing operation was repeatedly performed five times. Regarding the water washing operation, operations of adding 2 L of pure water (20° C.) to 500 g of a powder, stirring the mixture for 10 minutes at 300 rpm, subsequently leaving the mixture to stand for 30 minutes, allowing the powder to settle, and removing the supernatant with a tube pump, were considered as one round. After completion of the water washing operation, the obtained powder was sufficiently dried at 110° C.

A barium titanate powder of Experimental Example 3 was obtained by the above-described operations. Next, for the obtained barium titanate powder, measurement of the true specific gravity, the average degree of sphericity, the average particle size, the extraction water electrical conductance, and the BET specific surface area, and evaluation of the dielectric constant were performed. The results are shown in Table 2.

### Experimental Example 4

Step b1 (calcination step) and step b2 (washing step) were carried out in the same manner as in Experimental Example 3, except that a powder collected by a cyclone (CY product) was used instead of the powder collected by a heat exchanger (heat exchange product), and a barium titanate powder of Experimental Example 4 was obtained. Next, for the obtained barium titanate powder, measurement of the true specific gravity, the average degree of sphericity, the average particle size, the extraction water electrical conductance, and the BET specific surface area, and evaluation of the dielectric constant were performed in the same manner as in Experimental Examples 1 and 2. The results are shown in Table 2.

### Experimental Example 5

Step a (formation of barium titanate particles) and step d (classification of powder including barium titanate particles) were carried out in the same manner as in Experimental Examples 1 and 2, and then step b1 (calcination step) and step b2 (washing step) were carried out on a powder collected by a heat exchanger (heat exchange product) in the same manner as in Experimental Example 3. That is, in the present Experimental Example, a powder having an average particle size of 9.0 to 12.0 μm and a true specific gravity of 5.60 to 5.90 g/cm³ was used in step b1. Thereafter, the obtained dried powder was subjected to a calcination step (second calcination step) as step c. Specifically, 8 kg of the dried powder was charged into a mullite sheath, the temperature was increased to 1000° C. at a temperature increase rate of 3.3° C./min, and then the powder was calcined at 1000° C. for 6 hours. As a result, a barium titanate powder of Experimental Example 5 was obtained. Cooling after calcination in step c was performed by natural cooling in a furnace. Next, for the obtained barium titanate powder, measurement of the true specific gravity, the average degree of sphericity, the average particle size, the extraction water electrical conductance, and the BET specific surface area, and evaluation of the dielectric constant were performed in the same manner as in Experimental Examples 1 and 2. The results are shown in Table 2.

### Experimental Example 6

Step a (formation of barium titanate particles) and step d (classification of a powder including barium titanate particles) were carried out in the same manner as in Experimental Examples 1 and 2, and then step b1 (calcination step) and step b2 (washing step) were carried out for a powder collected by a cyclone (CY product) in the same manner as in Experimental Example 4. That is, in the present Experimental Example, a powder having an average particle size of 3.0 to 5.0 μm and a true specific gravity of 5.60 to 5.90 g/cm³ was used in step b1. Next, the obtained dry powder was subjected to step c (second calcination step) in the same manner as in Experimental Example 5, and a barium titanate powder of Experimental Example 6 was obtained. Next, for the obtained barium titanate powder, measurement of the true specific gravity, the average degree of sphericity, the average particle size, the extraction water electrical conductance, and the BET specific surface area, and evaluation of the dielectric constant were performed in the same manner as in Experimental Examples 1 and 2. The results are shown in Table 2.

### Experimental Example 7

A barium titanate powder of Experimental Example 7 was obtained in the same manner as in Experimental Example 5, except that step b1 (calcination step) was not carried out. Next, for the obtained barium titanate powder, measurement of the true specific gravity, the average degree of sphericity, the average particle size, the extraction electrical conductance, and the BET specific surface area, and evaluation of the dielectric constant were performed in the same manner as in Experimental Examples 1 and 2. The results are shown in Table 2.

### Experimental Example 8

The barium titanate powder of Experimental Example 5 and the barium titanate powder of Experimental Example 6 were mixed at a mass ratio of 6:4, and a barium titanate powder of Experimental Example 8 was obtained. Next, for the obtained barium titanate powder, measurement of the true specific gravity, the average degree of sphericity, the average particle size, the extraction electrical conductance, and the BET specific surface area, and evaluation of the dielectric constant were performed in the same manner as in Experimental Examples 1 and 2. The results are shown in Table 3.

### Experimental Example 9

The barium titanate powder of Experimental Example 3 and the barium titanate powder of Experimental Example 4 were mixed at a mass ratio of 6:4, and a barium titanate powder of Experimental Example 9 was obtained. Next, for the obtained barium titanate powder, measurement of the true specific gravity, the average degree of sphericity, the average particle size, the extraction electrical conductance, and the BET specific surface area, and evaluation of the dielectric constant were performed in the same manner as in Experimental Examples 1 and 2. The results are shown in Table 3.

### <Analysis and Evaluation>

### [Observation of Surface State]

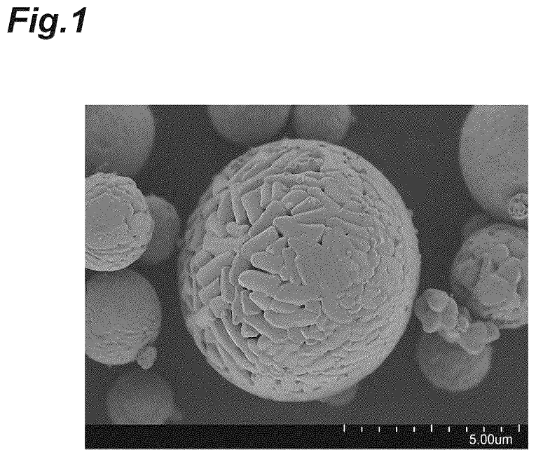

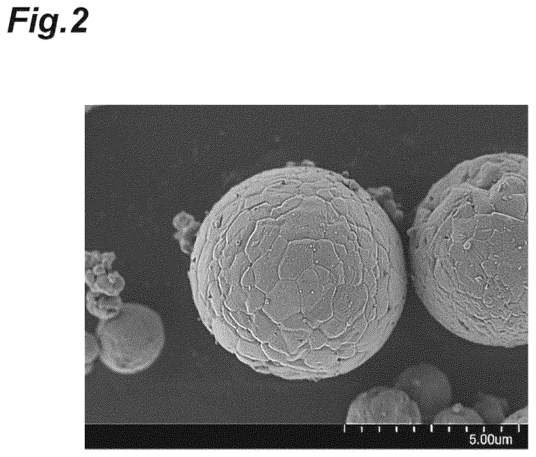

Barium titanate-based particles were taken out from the barium titanate particles of Experimental Example 4 and the barium titanate powder of Experimental Example 6, and the particles were observed with a scanning electron microscope (SEM) to obtain surface SEM images. The obtained surface SEM images are shown in FIG. 1 and FIG. 2. FIG. 1 is a surface SEM image of the barium titanate particles of Experimental Example 4, and FIG. 2 is a surface SEM image of the barium titanate particles of Experimental Example 6. From FIG. 1 and FIG. 2, it was verified that there were fewer voids present at the surface of the particles in Experimental Example 6 as compared to Experimental Example 4.

### [Observation of Cross-Section State]

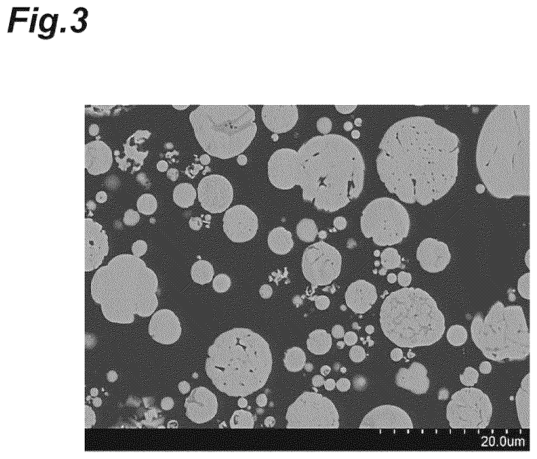

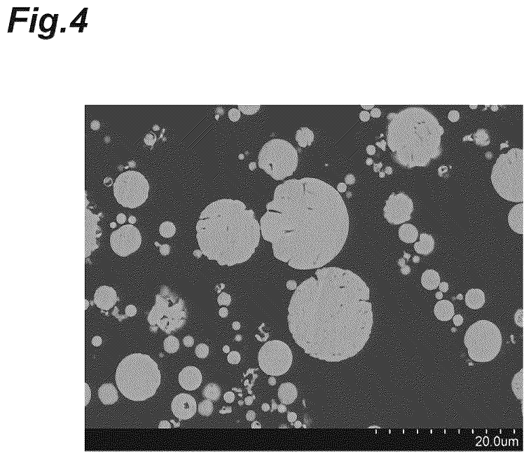

Cross-sections of the barium titanate particles of Experimental Example 4 and the barium titanate particles of Experimental Example 6 were observed. Specifically, first, 0.1 g of a barium titanate powder was embedded in 0.3 g of an epoxy resin “G2” manufactured by GATAN. Next, a degassing treatment was performed at 90° C. for 90 minutes, subsequently the epoxy resin was cured by heating at 130° C. for 30 minutes, and a resin molded body including the barium titanate powder was obtained. At this time, the size of the resin molded body was about 5 mm×10 mm×3 mm. After curing, the resin surface was polished by using SiC paper to perform surface leveling, and milling was performed by using an ion milling apparatus (trade name “IM4000Plus”) manufactured by Hitachi High-Tech Corporation. Thereafter, an osmium coating treatment was performed by using an osmium coater (trade name “HPC-20”) manufactured by Vacuum Device Co., Ltd. Next, the coating-treated surface was observed with a scanning electron microscope (SEM), and cross-sectional SEM images were acquired. The obtained cross-sectional SEM images are shown in FIG. 3 and FIG. 4. FIG. 3 is a cross-sectional SEM image of the barium titanate particles of Experimental Example 4, and FIG. 4 is a cross-sectional SEM image of the barium titanate particles of Experimental Example 6. From FIG. 3 and FIG. 4, it was verified that in Experimental Example 6, there were fewer voids (hollow parts) present in the cross-sections of the particles, and solid particles were formed, as compared to Experimental Example 4.

### [Measurement of Hollow Area Ratio]

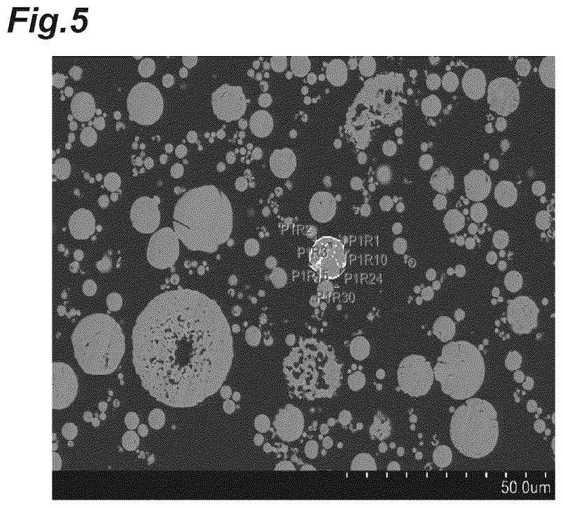

Using the cross-sectional SEM images obtained by the above-described observation of cross-sections, the hollow area ratio in the cross-sections of the particles was measured for the barium titanate powders of Experimental Examples 3 to 9. Specifically, first, the cross-sectional SEM images were imported into image analysis software “ImagePRO”, the particles were recognized by using an automatic tracing tool as shown in FIG. 5, subsequently the brightness range was set to 0 to 150 from a binarization tool window, and the area of the cross-section of a particle and the area of hollow parts existing within the cross-section (sum of the areas of all the hollow parts) were measured. Regarding the measurement, thirty particles whose cross-sectional diameters fell in the range of +20% of the average particle size measured as described above were randomly extracted from a plurality of cross-sectional SEM images, and the measurement was performed for the extracted thirty particles. Next, the hollow area ratio in a cross-section of each particle ([sum of areas of hollow parts/cross-sectional area of particle]×100) was calculated from the measured values. The average value of the obtained hollow area ratios of the thirty particles was determined, and this was taken as hollow area ratio of the barium titanate particles. The results are shown in Tables 2 and 3.

TABLE 2

| | | Experimental | Experimental | Experimental | Experimental | Experimental |
|---|---|---|---|---|---|---|
| | | Example 3 | Example 4 | Example 5 | Example 6 | Example 7 |
| Type of powder used | | Heat exchange | CY product | Heat exchange | CY product | Heat exchange |
| | | product | | product | | product |
| Step b | Calcination | Present | Present | Present | Present | Absent |
| | Washing | Present | Present | Present | Present | Present |
| Step c | Calcination | Absent | Absent | Present | Present | Present |

| | | | | | |
|---|---|---|---|---|---|
| True specific gravity (—) | 5.93 | 5.94 | 5.92 | 5.97 | 5.90 |
| Average degree of | 0.88 | 0.89 | 0.90 | 0.87 | 0.89 |
| sphericity (—) | | | | | |
| Average particle size | 11.0 | 4.3 | 11.1 | 4.4 | 11.0 |
| (μm) | | | | | |
| Extraction water | 23 | 30 | 29 | 36 | 24 |
| electrical conductance | | | | | |
| (μS/cm) | | | | | |
| BET specific surface | 0.36 | 0.92 | 0.28 | 0.66 | 0.30 |
| area (m²/g) | | | | | |
| Dielectric constant of | 26 | 31 | 28 | 35 | 26 |
| resin cured product (—) | | | | | |
| Hollow area ratio | 8.2% | 7.7% | 4.7% | 4.3% | 6.5% |

TABLE 3

| | Experimental | Experimental |
|---|---|---|
| | Example 8 | Example 9 |
| Type of powder used | Heat exchange | Heat exchange |
| | product/CY | product/CY |
| | product | product |
| True specific gravity (—) | 5.95 | 5.91 |
| Average degree of sphericity (—) | 0.90 | 0.89 |
| Average particle size (μm) | 7.3 | 7.1 |
| Extraction water electrical | 33 | 27 |
| conductance (μS/cm) | | |
| BET specific surface area (m²/g) | 0.43 | 0.55 |
| Dielectric constant of resin cured | 31 | 28 |
| product (—) | | |
| Hollow area ratio | 4.5% | 7.9% |

In Experimental Examples 5 and 7, the hollow area ratios of the particles were lower, and resin cured products having a higher dielectric constant were obtained, as compared to Experimental Example 3 in which a barium titanate powder having an average particle size of the same order was obtained. Similarly, in Experimental Example 6, the hollow area ratio of the particles was lower, and a resin cured product having a higher dielectric constant was obtained, as compared to Experimental Example 4 in which a barium titanate powder having an average particle size of the same order was obtained. Similarly, in Experimental Example 8, the hollow area ratio of the particles was lower, and a resin cured product having a higher dielectric constant was obtained, as compared to Experimental Example 9 in which a barium titanate powder having an average particle size of the same order was obtained. From these matters, it was verified that irrespective of the particle size range of the powder to be treated, the hollow area ratio of the particles is reduced by performing calcination after washing, and the dielectric constant of the powder is improved.

1. A method for producing a barium titanate-based powder, the method comprising:
step a of spraying a raw material comprising a barium titanate-based compound into a high-temperature field heated to a temperature equal to or higher than a melting point of the compound to form barium titanate-based particles;
step b of washing a powder comprising the barium titanate-based particles formed in the step a, or calcining a powder comprising the barium titanate-based particles formed in the step a and then washing the calcined powder; and
step c of calcining the washed powder obtained through the step b.

2. The method for producing a barium titanate-based powder according to claim 1, further comprising:
step d of classifying a powder comprising the barium titanate-based particles formed in the step a and obtaining a plurality of powders having different average particle sizes,
wherein in the step b, among the plurality of powders obtained in the step d, a powder having an average particle size of 3.0 to 5.0 μm and a true specific gravity of 5.60 to 5.90 g/cm³ is used as the powder comprising the barium titanate-based particles formed in the step a.

3. The method for producing a barium titanate-based powder according to claim 1, further comprising:
step d of classifying a powder comprising the barium titanate-based particles formed in the step a and obtaining a plurality of powders having different average particle sizes,
wherein in the step b, among the plurality of powders obtained in the step d, a powder having an average particle size of 9.0 to 12.0 μm and a true specific gravity of 5.60 to 5.90 g/cm³ is used as the powder comprising the barium titanate-based particles formed in the step a.

4. The method for producing a barium titanate-based powder according to claim 1, wherein in the step b, a powder comprising the barium titanate-based particles formed in the step a is calcined, and then the calcined powder is washed.

5. A barium titanate-based powder comprising barium titanate-based particles,
wherein the barium titanate-based particles have a hollow area ratio in a cross-section of 5.0% or less.

6. The barium titanate-based powder according to claim 5, wherein the barium titanate-based powder has an average particle size of 3.0 to 12.0 μm.

7. The barium titanate-based powder according to claim 5, wherein the barium titanate-based powder has an average degree of sphericity of 0.80 or greater.

8. The barium titanate-based powder according to claim 5, wherein the barium titanate-based powder has an average particle size of 3.0 to 5.0 μm and a BET specific surface area of 0.60 to 0.70 m²/g.

9. The barium titanate-based powder according to claim 5, wherein the barium titanate-based powder has an average particle size of 6.0 to 8.0 μm and a BET specific surface area of 0.40 to 0.50 m²/g.

10. The barium titanate-based powder according to claim 5, wherein the barium titanate-based powder has an average particle size of 9.0 to 12.0 μm and a BET specific surface area of 0.25 to 0.30 m²/g.

11. The barium titanate-based powder according to claim 5, wherein when extraction water is prepared by mixing 30 g of the powder, 142.5 mL of ion-exchanged water having an electrical conductance of 1 μS/cm or less, and 7.5 mL of ethanol with a purity of 99.5% or higher, shaking the mixture for 10 minutes, and then leaving the mixture to stand for 30 minutes, the extraction water has an electrical conductance of 200 μS/cm or less.

12. A filler for a sealing material, comprising the barium titanate-based powder according to claim 5.
